(19) United States
(12) Patent Application Publication
(10) Pub. No.: US 2016/0083560 A1
(43) Pub. Date: Mar. 24, 2016

(54) HALOGEN-FREE FLAME RETARDANT TPU

(71) Applicant: LUBRIZOL ADVANCED MATERIALS, INC., Cleveland, IA (US)

(72) Inventors: Bela B Fudala, VE Maastricht (NL); Ann Giovannitti-Jensen, Bay Village, OH (US); Nico Rems, Hoegaarden (BE); Wim Cravillon, Westerlo-Oevel (BE); Chetan M. Makadia, Strongsville, OH (US)

(21) Appl. No.: 14/784,966

(22) PCT Filed: Apr. 21, 2014
(86) PCT No.: PCT/US2014/034783

§ 371 Date: Oct. 16, 2015

Related U.S. Application Data
(60) Provisional application No. 61/816,991, filed on Apr. 29, 2013.

(51) Int. Cl. C08K 5/3492; C08K 3/32; C08K 5/521

(52) U.S. Cl. CPC C08K 5/34924; C08K 5/521; C08K 3/32

(57) ABSTRACT

The present invention relates to flame retardant thermoplastic polyurethane (TPU) compositions, and more particularly to flame retardant thermoplastic polyurethane compositions comprising non-halogen flame retardants. The TPU compositions of this invention are useful for applications where high flame performance, optionally low smoke properties, as well as high tensile strength are desirable, such as wire and cable applications, film applications, molding applications, and the like. This invention also relates to processes to produce the described non-halogen flame retardant TPU compositions and processes to produce wire and cable jacketing from such compositions.

### FIELD OF THE INVENTION

The present invention relates to flame retardant thermoplastic polyurethane (TPU) compositions, and more particularly to flame retardant thermoplastic polyurethane compositions comprising non-halogen flame retardants. The TPU compositions of this invention are useful for applications where high flame performance, optionally low smoke properties, as well as high tensile strength are desirable, such as wire and cable applications, film applications, molding applications, and the like. This invention also relates to processes to produce the described non-halogen flame retardant TPU compositions and processes to produce wire and cable jacketing from such compositions.

### BACKGROUND OF THE INVENTION

Halogen additives, such as those based on fluorine, chlorine, and bromine, have been used to give flame retardant properties to TPU compositions. In recent years, certain end use applications that contain TPU specify that the TPU composition be halogen-free. This has required TPU formulators to search for other flame retardants to replace the previously used halogen additives.

U.S. Pat. No. 6,777,466 assigned to Noveon IP Holding Co. discloses the use of melamine cyanurate as the only organic flame retardant additive in a thermoplastic polyurethane composition.

U.S. Pat. No. 5,837,760 assigned to Elastogram GmbH discloses a self-extinguishing flame retardant, thermoplastic polyurethane that contains one or more organic phosphonates and one or more organic phosphonates mixed with a melamine derivative.

U.S. Pat. No. 5,110,850 assigned to B.F. Goodrich Co. discloses halogen-free flame retardant thermoplastic polymers where the sole flame retardant is a melamine that is free of melamine derivatives.

WO 2006/121549 assigned to Noveon, Inc. discloses a thermoplastic polyurethane containing a flame retardant combination including phosphinate compounds, phosphate compounds and a pentaerythritol and dipentaerythritol component.

WO 2012/067685 assigned to Lubrizol, Inc., discloses very similar thermoplastic polyurethane compositions. However the thermoplastic polyurethane compositions of the reference do not have high enough Limiting Oxygen Index (LOI) values and/or flame retardant properties to be useful in all applications.

Flame specifications for many applications, including shipboard cables, have recently become more stringent. Coupled with the ongoing movement away from halogen-containing additives, there are currently no non-halogenated flame retardant TPU-based products on the market that can pass the more demanding cable flame tests, such as CSA FT-4 for shipboard cables. Thus, there is a need for TPU compositions and TPU-based products with improved high flame retardant properties that would be suitable for such applications, while not impairing mechanical strength and processability of the TPU. More specifically, there is a need for TPU compositions that can be used in cable sheathing applications, where the TPU compositions can pass EL1581 section 1061 cable flam testing while also providing strong mechanical properties, for example a tensile strength of at least 25 MPa.

It is desirable to provide a TPU composition with the desired flame retardant properties but also good mechanical properties such as good tensile strength and/or high flexibility, while in at least some cases also being halogen-free. It is also desirable to provide a TPU composition with improved flame retardant characteristics, such that the material will pass high level flame tests, have good intumescent and char forming properties, and optionally possess low smoke properties, again in some cases without the need for halogen-containing materials.

The present invention meets these ongoing needs.

### SUMMARY OF THE INVENTION

The present invention provides a flame retardant thermoplastic polyurethane composition that includes: (a) a thermoplastic polyurethane resin, (b) an inorganic aluminum phosphinate, (c) a melamine derivative, (d) a polyhydric alcohol; and (e) one or more fillers that includes talc, where the inorganic aluminum phosphinate makes up less than 18 percent by weight of the flame retardant thermoplastic polyurethane composition, and where the talc makes up less than 10 percent by weight of the flame retardant thermoplastic polyurethane composition. In some embodiments, the inorganic aluminum phosphinate makes up no more than 15 percent by weight of the flame retardant thermoplastic polyurethane composition. In some embodiments, the thermoplastic polyurethane resin makes up from 62 to 71 percent by weight of the flame retardant thermoplastic polyurethane composition.

The invention further provides a flame retardant thermoplastic polyurethane composition that includes: (a) a thermoplastic polyurethane resin, (b) an inorganic aluminum phosphinate, (c) an additional flame retardant additive; and (d) one or more fillers that includes talc, where the inorganic aluminum phosphinate makes up more than 15 percent by weight of the flame retardant thermoplastic polyurethane composition, where the talc makes up less than 10 percent by weight of the flame retardant thermoplastic polyurethane composition, where the additional flame retardant additive comprises a melamine derivative, a polyhydric alcohol, or a combination thereof, and where the thermoplastic polyurethane resin makes up more than 60 percent by weight of the flame retardant thermoplastic polyurethane composition.

The invention further provides a flame retardant thermoplastic polyurethane composition that includes: (a) a thermoplastic polyurethane resin, (b) an inorganic aluminum phosphinate, (c) a phosphate ester, (d) an additional flame retardant additive, and (e) one or more fillers that includes talc, where the talc makes up less than 10 percent by weight of the flame retardant thermoplastic polyurethane composition, where the additional flame retardant additive comprises a melamine derivative, a polyhydric alcohol, or a combination thereof. In some embodiments, the inorganic aluminum phosphinate makes up more than 7 percent by weight of the flame retardant thermoplastic polyurethane composition. In some embodiments, the phosphate ester makes up at least 4 percent by weight of the flame retardant thermoplastic polyurethane composition.

The flame retardant thermoplastic polyurethane compositions of the invention may further include one or more antioxidants.

The flame retardant thermoplastic polyurethane compositions of the invention may further include one or more phosphate esters.

The invention further provides for any of the compositions described herein where each of the components (a), (b), and (c) are each essentially halogen free, or even completely halogen-free.

The invention further provides for any of the compositions described herein where the thermoplastic polyurethane resin includes a polyether thermoplastic polyurethane, a polyester thermoplastic polyurethane, a polycarbonate thermoplastic polyurethane, or any combination thereof.

The thermoplastic polyurethane resin may have a molecular weight ranging from 100,000 to 700,000.

The invention further provides for any of the compositions described herein where component (b) includes an inorganic aluminum salt of phosphinic acid represented by the formula: [R¹R²P(O)O]⁻₃Al³⁺, an inorganic aluminum salt of diphosphinic acid represented by the formula: [O(O)PR¹—R³—PR²(O)O]²⁻₃Al³⁺₂, a polymer of one or more thereof, or any combination thereof, wherein R¹ and R² are hydrogen and R³ is an alkyl group.

The invention further provides for any of the compositions described herein where component (b) further includes (i) an inorganic aluminum salt of phosphinic acid represented by the formula: [R¹R²P(O)O]⁻ₘM^{m+}, (ii) an inorganic metal salt of diphosphinic acid represented by the formula: [O(O)PR¹—R³—PR²(O)O]²⁻ₙMₓ^{m+}, (iii) a polymer of one or more thereof, or (iv) any combination thereof, wherein: R¹ and R² are hydrogen; R³ is an alkyl group; M is a metal chosen from the group consisting of Mg, Ca, Al, Sb, Sn, Ge, Ti, Zn, Fe, Zr, Ce, Bi, Sr, Mn, Li, Na, and K; and m, n and x are each independently equal or different integers in the range of 1-4.

The invention further provides for any of the compositions described herein where component (c) comprises melamine cyanurate, melamine phosphate, melamine polyphosphate, melamine borate, or any combination thereof. In some embodiments component (c) includes melamine cyanurate.

The invention further provides for any of the compositions described herein where the composition is essentially free of (i) polyamides, (ii) organic metal phosphinates, or both. The compositions described herein may also be completely free of (i) polyamides, (ii) organic metal phosphinates, or both. The compositions described herein may also be essentially free of or even completely free of polyester resins and polyolefinic polymers like polypropylene polymers.

The invention further provides a process of making any of the flame retardant thermoplastic polyurethane compositions described herein. The process includes the step of mixing the components of the flame retardant thermoplastic polyurethane composition together. In some embodiments the process includes the step of (1) mixing: (a) a thermoplastic polyurethane resin, (b) an inorganic aluminum phosphinate, and (c) a melamine derivative, (d) a polyhydric alcohol, and (e) one or more fillers that includes talc, where the inorganic aluminum phosphinate makes up less than 18 percent by weight of the flame retardant thermoplastic polyurethane composition, and where the talc makes up less than 10 percent by weight of the flame retardant thermoplastic polyurethane composition; resulting in a flame retardant thermoplastic polyurethane composition.

In some embodiments the process includes the step of (1) mixing: (a) a thermoplastic polyurethane resin, (b) an inorganic aluminum phosphinate, and (c) an additional flame retardant additive, (d) one or more fillers that includes talc, where the inorganic aluminum phosphinate makes up more than 15 percent by weight of the flame retardant thermoplastic polyurethane composition, wherein the talc makes up less than 10 percent by weight of the flame retardant thermoplastic polyurethane composition, where the additional flame retardant additive comprises a melamine derivative, a polyhydric alcohol, or a combination thereof, and where the thermoplastic polyurethane resin makes up more than 60 percent by weight of the flame retardant thermoplastic polyurethane composition; resulting in a flame retardant thermoplastic polycarbonate composition.

In some embodiments the process includes the step of (1) mixing: (a) a thermoplastic polyurethane resin, (b) an inorganic aluminum phosphinate, (c) a phosphate ester, (d) an additional flame retardant additive, and (e) one or more fillers that includes talc, where the talc makes up less than 10 percent by weight of the flame retardant thermoplastic polyurethane composition, and where the additional flame retardant additive comprises a melamine derivative, a polyhydric alcohol, or a combination thereof; resulting in a flame retardant thermoplastic polycarbonate composition.

The invention further provides a method of improving the flame retardant properties of a thermoplastic polyurethane resin and/or composition described herein while maintaining the physical properties of the thermoplastic polyurethane resin and/or composition. The method includes the step of adding to (a) a thermoplastic polyurethane resin and/or composition a flame retardant package made up of the other components described herein. In some embodiments, the method includes the step of (1) adding to the thermoplastic polyurethane resin and/or composition: (b) an inorganic aluminum phosphinate, (c) a melamine derivative, (d) a polyhydric alcohol, and (e) one or more fillers that includes talc, where the inorganic aluminum phosphinate makes up less than 18 percent by weight of the flame retardant thermoplastic polyurethane composition, and where in the talc makes up less than 10 percent by weight of the flame retardant thermoplastic polyurethane composition; resulting in thermoplastic polycarbonate composition with acceptable physical properties and improved flame retardant properties.

In some embodiments, the method includes the step of (1) adding to the thermoplastic polyurethane resin and/or composition: (b) an inorganic aluminum phosphinate, (c) an additional flame retardant additive, and (d) one or more fillers that includes talc, where the inorganic aluminum phosphinate makes up more than 15 percent by weight of the flame retardant thermoplastic polyurethane composition, where the talc makes up less than 10 percent by weight of the flame retardant thermoplastic polyurethane composition, where the additional flame retardant additive comprises a melamine derivative, a polyhydric alcohol, or a combination thereof, and where the thermoplastic polyurethane resin makes up more than 60 percent by weight of the flame retardant thermoplastic polyurethane composition; resulting in thermoplastic polycarbonate composition with acceptable physical properties and improved flame retardant properties.

In some embodiments, the method includes the step of (1) adding to the thermoplastic polyurethane resin and/or composition: (b) an inorganic aluminum phosphinate, (c) a phosphate ester, (d) and additional flame retardant additive, and (e) one or more fillers that includes talc, where the talc makes up less than 10 percent by weight of the flame retardant thermoplastic polyurethane composition, and where the additional flame retardant additive comprises a melamine derivative, a polyhydric alcohol, or a combination thereof; resulting in thermoplastic polycarbonate composition with acceptable physical properties and improved flame retardant properties.

The invention further provides a use of any of the additive compositions described herein, as suitable for adding to (a) a thermoplastic polyurethane resin and/or composition, as a flame retardant properties booster for a thermoplastic polyurethane resin and/or composition. In some embodiments, the additive composition for use as a flame retardant properties booster for a thermoplastic polyurethane resin and/or composition includes: (b) an inorganic aluminum phosphinate, (c) a melamine derivative, (d) a polyhydric alcohol, and (e) one or more fillers that includes talc, where the inorganic aluminum phosphinate makes up less than 18 percent by weight of the flame retardant thermoplastic polyurethane composition, and where the talc makes up less than 10 percent by weight of the flame retardant thermoplastic polyurethane composition; resulting in thermoplastic polycarbonate composition with acceptable physical properties and improved flame retardant properties.

In some embodiments, the additive composition for use as a flame retardant properties booster for a thermoplastic polyurethane resin and/or composition includes: (b) an inorganic aluminum phosphinate, (c) an additional flame retardant additive, and (d) one or more fillers that includes talc, where the inorganic aluminum phosphinate makes up more than 15 percent by weight of the flame retardant thermoplastic polyurethane composition. where the talc makes up less than 10 percent by weight of the flame retardant thermoplastic polyurethane composition, where the additional flame retardant additive comprises a melamine derivative, a polyhydric alcohol, or a combination thereof, and where the thermoplastic polyurethane resin makes up more than 60 percent by weight of the flame retardant thermoplastic polyurethane composition; resulting in thermoplastic polycarbonate composition with acceptable physical properties and improved flame retardant properties.

In some embodiments, the additive composition for use as a flame retardant properties booster for a thermoplastic polyurethane resin and/or composition includes: (b) an inorganic aluminum phosphinate, (c) a phosphate ester, (d) an additional flame retardant additive, and (e) one or more fillers that includes talc, where the talc makes up less than 10 percent by weight of the flame retardant thermoplastic polyurethane composition, and where the additional flame retardant additive comprises a melamine derivative, a polyhydric alcohol, or a combination thereof; resulting in thermoplastic polycarbonate composition with acceptable physical properties and improved flame retardant properties.

The invention further provides for any of the flame retardant thermoplastic polyurethane compositions described herein, where the composition: (i) has a tensile strength, as measured by VDE282 part 10 (250 mm/min), of at least 24 MPa; (ii) has a percent elongation at break, as measured by VDE282 part 10 (250 mm/min), of at least 525%; (iii) has a LOI, as measured by ASTM D2863, of at least 27; and (iv) has a UL-94 rating of V0.

The invention further provides for any of the flame retardant thermoplastic polyurethane compositions described herein, where the composition: (i) has a tensile strength, as measured by VDE282 part 10 (250 mm/min), of at least 38 MPa; (ii) has a percent elongation at break, as measured by VDE282 part 10 (250 mm/min), of at least 500%; (iii) has a LOI, as measured by ASTM D2863, of at least 25.5; and (iv) has a UL-94 rating of V0.

The invention further provides for any of the flame retardant thermoplastic polyurethane compositions described herein, where the composition: (i) has a tensile strength, as measured by VDE282 part 10 (250 mm/min), of at least 33 MPa; (ii) has a percent elongation at break, as measured by VDE282 part 10 (250 mm/min), of at least 323%; (iii) has a LOI, as measured by ASTM D2863, of at least 25.5; and (iv) has a UL-94 rating of V0.

The invention further provides for any of the flame retardant thermoplastic polyurethane compositions described here, where the thermoplastic polyurethane resin is included from 45 to 92 percent by weight; the inorganic aluminum phosphinate is included from at least 5 to less than 15 percent by weight; the melamine derivative, when present is included from 1 to 20 percent by weight; the polyhydric alcohol when present is included from at least 1 to 10 percent by weight; and the one or more fillers that includes talc is included from at least 1 to less than 10 percent by weight (where all percent by weight values are in regards to the overall flame retardant thermoplastic polyurethane compositions. In some embodiments, the thermoplastic polyurethane resin is present from 45 to 92, or from 45 to 90, or from 50 to 90, or from 50 to 80, or from 59 to 77, or from 65 to 74, or from 64.8 to 73.8 percent by weight. In some embodiments, the inorganic aluminum phosphinate is present from 5 to less than 15, or from 5 to 14.8, or from 5.95 to 14.8, or from 6 to less than 15, or from 8.5 to less than 15, or even from 8.5 to 14.8 percent by weight. In some embodiments, the melamine derivative is present from 1 to 20, or from 1 to 16, or from 2 to 16, or from 8 to 15 percent by weight. In some embodiments the polyhydric alcohol is present from 1 to 10, or from 1 to 5, or from 4 to 10, or from 4.7 to 5 percent by weight. In some embodiments, the one or more fillers is present from 1 to less than 10, or from 1 to 9, or from 1 to 5, or from 2 to 5, or from 1 to 3, or from 2 to 3, or from 2.5 to 3, or from 2.7 to 3 percent by weight. In some embodiments, the compositions further include one or more antioxidants which may be present from 0 to 10, or from 0.1 to 10, or from 0.1 to 1, or from 0.1 to 0.5, or from 0.1 to 0.3, or even about 0.2 percent by weight. In some embodiments, the compositions further include one or more phosphate esters which may be present from 0 to 10, or from 1 to 10, or from 2 to 7, or from 2.8 to 7.2, or from 3 to 7, or from 0 to 7, o from 0 to 6.8 percent by weight.

The invention further provides for any of the flame retardant thermoplastic polyurethane compositions described here, where the thermoplastic polyurethane resin is included from 45 to 83 percent by weight; the inorganic aluminum phosphinate is included from at least 15 percent by weight; the additional flame retardant additive, when present is included from 1 to 30 percent by weight; and the one or more fillers that includes talc is included from at least 1 to less than 10 percent by weight (where all percent by weight values are in regards to the overall flame retardant thermoplastic polyurethane compositions. In some embodiments, the thermoplastic polyurethane resin is present from 45 to 83, or from 45 to 82, or from 50 to 90, or from 50 to 80, or from 59 to 77, or from 65 to 74, or from 64.8 to 73.8, or even from more than 60 percent by weight. In some embodiments, the inorganic aluminum phosphinate is present from at least 15, or from 15 to 30, or from 15.3 to 30, or from 15 to 20, or from 15.3 to 18, or from 15.3 to 16.2 percent by weight. In some embodiments, the additional flame retardant additive is present from 1 to 30, or from 1 to 25, or from 2 to 25, or from 10 to 20, or from 13 to 20 percent by weight. In some embodiments, the one or more fillers is present from 1 to less than 10, or from 1 to 9, or from 1 to 5, or from 2 to 5, or from 1 to 3, or from 2 to 3, or from 2.5 to 3, or from 2.7 to 3 percent by weight. In some embodiments, the compositions further include one or more antioxidants which may be present from 0 to 10, or from 0.1 to 10, or from 0.1 to 1, or from 0.1 to 0.5, or from 0.1 to 0.3, or even about 0.2 percent by weight. In some embodiments, the compositions further include one or more phosphate esters which may be present from 0 to 10, or from 1 to 10, or from 2 to 7, or from 2.8 to 7.2, or from 3 to 7, or from 0 to 7, or from 0 to 6.8 percent by weight.

The invention further provides for any of the flame retardant thermoplastic polyurethane compositions described here, where the thermoplastic polyurethane resin is included from 45 to 96 percent by weight; the inorganic aluminum phosphinate is included from 5 to less than 15 percent by weight; the phosphate ester, when present, is included from 1 to 20 percent by weight; the additional flame retardant additive, when present is included from 1 to 10 percent by weight; and the one or more fillers that includes talc is included from at least 1 to less than 10 percent by weight (where all percent by weight values are in regards to the overall flame retardant thermoplastic polyurethane compositions. In some embodiments, the thermoplastic polyurethane resin is present from 45 to 96, or from 45 to 82, or from 50 to 90, or from 50 to 80, or from 59 to 77, or from 65 to 74, or from 64.8 to 73.8, or even from more than 60 percent by weight. In some embodiments, the inorganic aluminum phosphinate is present from 1 to 30, or from 5 to 30, or from 7 to 30, or from 8 to 30, or from 8 to 20, or from 8.5 to 15.3 percent by weight. In some embodiments, the phosphate ester is present from 1 to 30, or from 1 to 20, or from 4 to 20, or from 4 to 10, or from 4 to 8, or from 4 to 7.2, or even from more than 7 percent by weight. In some embodiments, the additional flame retardant additive is present from 1 to 30, or from 1 to 20, or from 2 to 20, or from 2 to 13 percent by weight. In some embodiments, the one or more fillers is present from 1 to less than 10, or from 1 to 9, or from 1 to 5, or from 2 to 5, or from 1 to 3, or from 2 to 3, or from 2.5 to 3, or from 2.7 to 3 percent by weight. In some embodiments, the compositions further include one or more antioxidants which may be present from 0 to 10, or from 0.1 to 10, or from 0.1 to 1, or from 0.1 to 0.5, or from 0.1 to 0.3, or even 4099-01 about 0.2 percent by weight. In some embodiments, the compositions further include one or more phosphate esters which may be present from 0 to 10, or from 1 to 10, or from 2 to 7, or from 2.8 to 7.2, or from 3 to 7, or from 0 to 7, o from 0 to 6.8 percent by weight.

### DETAILED DESCRIPTION OF THE INVENTION

The thermoplastic polyurethane (TPU) compositions of the present invention are flame retardant TPU compositions that include: (a) a TPU resin; (b) an inorganic phosphinate; and (c) a melamine derivative. In some embodiments, component (a), the TPU resin, component (b), the inorganic phosphinate, and component (c), the melamine derivative, are each essentially halogen-free, or even completely halogen-free.

There is ongoing desire for materials that combine excellent flame retardant properties with excellent physical properties. Often one has to choose between one or the other, and deal with less than excellent properties in one of the areas. For example, many polyether TPU compositions have excellent physical properties but poor flame retardant properties. Using additives to improve the flame retardant properties of such composition can provide excellent properties, but generally at the expense of the excellent physical properties, as the TPU composition may become brittle or otherwise impaired. Thus finding a TPU composition that provides excellent flame retardant properties while maintaining the excellent physical properties is a goal that continues to elude the industry. The present invention provides a new composition with this optimal balance of properties.

### The TPU Component

The TPU resin and/or polymer suitable for use in this invention include any TPU polymer. The TPU polymer component of the present invention may include a polyether TPU, a polyester TPU, a polycarbonate TPU, or any combination thereof. The compositions of this invention may also include one or more other polymeric materials, blended with the TPU.

TPU is generally made by reacting a polyisocyanate with at least one diol chain extender, and optionally one or more hydroxyl terminated intermediates. U.S. Pat. No. 6,777,466 to Eckstein et al. provides detailed disclosure of processes to provide certain TPU polymers that may be utilized in embodiments of the present invention and is incorporated herein in its entirety.

Suitable polyisocyanates to make the TPU include aromatic diisocyanates such as 4,4′-methylenebis-(phenyl isocyanate) (MDI), m-xylene diisocyanate (XDI), phenylene-1,4-diisocyanate, naphthalene-1,5-diisocyanate, and toluene diisocyanate (TDI); as well as aliphatic diisocyanates such as isophorone diisocyanate (IPDI), 1,4-cyclohexyl diisocyanate (CHDI), decane-1,10-diisocyanate, hexamethylene diisocyanate (HDI), and dicyclohexylmethane-4,4′-diisocyanate (H12MDI).

Mixtures of two or more polyisocyanates may be used. In some embodiments, the polyisocyanate is MDI and/or H12MDI. In some embodiments, the polyisocyanate may include MDI. In some embodiments, the polyisocyanate may include H12MDI.

Suitable chain extenders to make the TPU include relatively small polyhydroxy compounds, for example lower aliphatic or short chain glycols having from 2 up to about 20 or from 2 up to 12, or from 2 up to 10 carbon atoms. Suitable examples include ethylene glycol, diethylene glycol, propylene glycol, dipropylene glycol, 1,4-butanediol (BDO), 1,6-hexanediol (HDO), 1,3-butanediol, 1,5-pentanediol, neopentylglycol, 1,4-cyclohexanedimethanol (CHDM), 2,2-bis[4-(2-hydroxyethoxy)phenyl]propane (HEPP) and hydroxyethyl resorcinol (HER), and the like, as well as mixtures thereof. In some embodiments, the chain extenders are 1,4-butanediol and 1,6-hexanediol. Other glycols, such as aromatic glycols could be used, but in some embodiments the TPUs of the invention are not made using such materials.

In some embodiments, the chain extender used to prepare the TPU is substantially free of, or even completely free of, 1,6-hexanediol. In some embodiments, the chain extender used to prepare the TPU includes a cyclic chain extender. Suitable examples include CHDM, HEPP, HER, and combinations thereof. In some embodiments, the chain extender used to prepare the TPU includes an aromatic cyclic chain extender, for example HEPP, HER, or a combination thereof. In some embodiments, the chain extender used to prepare the TPU includes an aliphatic cyclic chain extender, for example CHDM. In some embodiments, the chain extender used to prepare the TPU is substantially free of, or even completely free of aromatic chain extenders, for example aromatic cyclic chain extenders.

Suitable polyols (hydroxyl terminated intermediates), when present, include one or more hydroxyl terminated polyesters, one or more hydroxyl terminated polyethers, one or more hydroxyl terminated polycarbonates or mixtures thereof.

Suitable hydroxyl terminated polyether intermediates that may be used to prepare any of the TPU materials of the invention include polyether polyols derived from a diol or polyol having a total of from 2 to 15 carbon atoms, in some embodiments an alkyl diol or glycol which is reacted with an ether comprising an alkylene oxide having from 2 to 6 carbon atoms, typically ethylene oxide or propylene oxide or mixtures thereof. For example, hydroxyl functional polyether can be produced by first reacting propylene glycol with propylene oxide followed by subsequent reaction with ethylene oxide. Primary hydroxyl groups resulting from ethylene oxide are more reactive than secondary hydroxyl groups and thus are preferred. Useful commercial polyether polyols include poly(ethylene glycol) comprising ethylene oxide reacted with ethylene glycol, poly(propylene glycol) comprising propylene oxide reacted with propylene glycol, and poly(tetramethylene glycol) comprising water reacted with tetrahydrofuran (PTMEG). In some embodiments, the polyether intermediate includes PTMEG, poly(propylene glycol), or even a combination thereof. Suitable polyether polyols also include polyamide adducts of an alkylene oxide and can include, for example, ethylenediamine adduct comprising the reaction product of ethylenediamine and propylene oxide, diethylenetriamine adduct comprising the reaction product of diethylenetriamine with propylene oxide, and similar polyamide type polyether polyols. Copolyethers can also be utilized in the current invention. Typical copolyethers include the reaction product of THF and ethylene oxide or THF and propylene oxide. These are available from BASF as Poly THF B, a block copolymer, and poly THF R, a random copolymer. The various polyether intermediates generally have a number average molecular weight (Mn) as determined by assay of the terminal functional groups which is an average molecular weight greater than about 700, such as from about 700 to about 10,000, from about 1000 to about 5000, or from about 1000 to about 2500. A particular desirable polyether intermediate is a blend of two or more different molecular weight polyethers, such as a blend of 2000 Mₙ and 1000 Mₙ PTMEG.

Suitable hydroxyl terminated polyester intermediates that may be used to prepare any of the additional TPU materials of the invention include linear polyesters having a number average molecular weight (Mn) of from about 500 to about 10,000, from about 700 to about 5,000, or from about 700 to about 4,000, and generally have an acid number generally less than 1.3 or less than 0.8. The molecular weight is determined by assay of the terminal functional groups and is related to the number average molecular weight. The polyester intermediates may be produced by (1) an esterification reaction of one or more glycols with one or more dicarboxylic acids or anhydrides or (2) by transesterification reaction, i.e., the reaction of one or more glycols with esters of dicarboxylic acids. Mole ratios generally in excess of more than one mole of glycol to acid are preferred so as to obtain linear chains having a preponderance of terminal hydroxyl groups. Suitable polyester intermediates also include various lactones such as polycaprolactone typically made from ε-caprolactone and a bifunctional initiator such as diethylene glycol. The dicarboxylic acids of the desired polyester can be aliphatic, cycloaliphatic, aromatic, or combinations thereof. Suitable dicarboxylic acids which may be used alone or in mixtures generally have a total of from 4 to 15 carbon atoms and include: succinic, glutaric, adipic, pimelic, suberic, azelaic, sebacic, dodecanedioic, isophthalic, terephthalic, cyclohexane dicarboxylic, and the like. Anhydrides of the above dicarboxylic acids such as phthalic anhydride, tetrahydrophthalic anhydride, or the like, can also be used. Adipic acid is a preferred acid. The glycols which are reacted to form a desirable polyester intermediate can be aliphatic, aromatic, or combinations thereof, including any of the glycol described above in the chain extender section, and have a total of from 2 to 20 or from 2 to 12 carbon atoms. Suitable examples include ethylene glycol, 1,2-propanediol, 1,3-propanediol, 1,3-butanediol, 1,4-butanediol, 1,5-pentanediol, 1,6-hexanediol, 2,2-dimethyl-1,3-propanediol, 1,4-cyclohexanedimethanol, decamethylene glycol, dodecamethylene glycol, and mixtures thereof.

Suitable hydroxyl terminated polycarbonates that may be used to prepare any of the additional TPU materials of the invention include those prepared by reacting a glycol with a carbonate. U.S. Pat. No. 4,131,731 is hereby incorporated by reference for its disclosure of hydroxyl terminated polycarbonates and their preparation. Such polycarbonates are linear and have terminal hydroxyl groups with essential exclusion of other terminal groups. The essential reactants are glycols and carbonates. Suitable glycols are selected from cycloaliphatic and aliphatic diols containing 4 to 40, and or even 4 to 12 carbon atoms, and from polyoxyalkylene glycols containing 2 to 20 alkoxy groups per molecular with each alkoxy group containing 2 to 4 carbon atoms. Diols suitable for use in the present invention include aliphatic diols containing 4 to 12 carbon atoms such as butanediol-1,4, pentanediol-1,4, neopentyl glycol, hexanediol-1,6, 2,2,4-trimethylhexanediol-1,6, decanediol-1,10, hydrogenated dilinoleylglycol, hydrogenated dioleylglycol; and cycloaliphatic diols such as cyclohexanediol-1,3, dimethylolcyclohexane-1,4, cyclohexanediol-1,4, dimethylolcyclohexane-1,3, 1,4-endomethylene-2-hydroxy-5-hydroxymethyl cyclohexane, and polyalkylene glycols. The diols used in the reaction may be a single diol or a mixture of diols depending on the properties desired in the finished product. Polycarbonate intermediates which are hydroxyl terminated are generally those known to the art and in the literature. Suitable carbonates are selected from alkylene carbonates composed of a 5 to 7 member ring. Suitable carbonates for use herein include ethylene carbonate, trimethylene carbonate, tetramethylene carbonate, 1,2-propylene carbonate, 1,2-butylene carbonate, 2,3-butylene carbonate, 1,2-ethylene carbonate, 1,3-pentylene carbonate, 1,4-pentylene carbonate, 2,3-pentylene carbonate, and 2,4-pentylene carbonate. Also, suitable herein are dialkylcarbonates, cycloaliphatic carbonates, and diarylcarbonates. The dialkylcarbonates can contain 2 to 5 carbon atoms in each alkyl group and specific examples thereof are diethylcarbonate and dipropylcarbonate. Cycloaliphatic carbonates, especially dicycloaliphatic carbonates, can contain 4 to 7 carbon atoms in each cyclic structure, and there can be one or two of such structures. When one group is cycloaliphatic, the other can be either alkyl or aryl. On the other hand, if one group is aryl, the other can be alkyl or cycloaliphatic. Examples of suitable diarylcarbonates, which can contain 6 to 20 carbon atoms in each aryl group, are diphenylcarbonate, ditolylcarbonate, and dinaphthylcarbonate.

Two or more polyols may be used in combination with one another to prepare the TPU materials described herein. While not wishing to be bound by theory it is believed the formulations of the invention will help to improve the flame retardancy of any TPU material while also preserving the mechanical properties of the TPU material relative to more conventional means of improving flame retardancy, which generally lead to impaired mechanical properties.

In some embodiments, one or more of the TPU polymers used in the invention is made by reacting a polyisocyanate with a chain extender, with or without any polyol being present. The reactants may be reacted together in a “one-shot” polymerization process wherein all of the components are added together simultaneously or substantially simultaneously to a heated extruder and reacted to form the TPU polymer. The reaction temperature utilizing urethane catalyst are generally from about 175° C. to about 245° C., and in some embodiments from about 180° C. to about 220° C. In some embodiments, the equivalent ratio of the diisocyanate to the total equivalents of the hydroxyl terminated intermediate and the diol chain extender is generally from about 0.95 to about 1.05, desirably from about 0.97 to about 1.03, or from about 0.98 to about 1.01.

The desired TPU resin used in the TPU compositions of the invention is generally made from the above-noted intermediates with a polyisocyanate, along with an extender glycol. In some embodiments, the reaction is carried out in a so-called one-shot process or simultaneous co-reaction of the hydroxyl-terminated intermediate, diisocyanate, and extender glycol to produce a high molecular weight linear TPU polymer. The preparation of the macroglycol is generally well known to the art and to the literature and any suitable method may be used. The weight average molecular weight (Mw) of the TPU polymer may generally be about 80,000 to 800,000, or even from about 90,000 to about 450,000 Daltons. The equivalent weight amount of diisocyanate to the total equivalent weight amount of hydroxyl containing components, that is the hydroxyl terminated intermediate, and chain extender glycol, may be from about 0.95 to about 1.10, or from about 0.96 to about 1.02, or from about 0.97 to about 1.005. In one embodiment, the TPU is substantially free of crosslinking and may even be completely free of any measurable crosslinking.

In one embodiment, the one-shot polymerization process generally occurs in situ, wherein a simultaneous reaction occurs between the components, that is, the one or more intermediates, the one or more polyisocyanates, and the one or more chain extenders. The reaction is generally initiated at temperatures of from about 100° C. to about 120° C. Inasmuch as the reaction is exothermic, the reaction temperature generally increases to about 220° C.-250° C. In one exemplary embodiment, the TPU polymer may be pelletized following the reaction.

The other components described herein, as well as any additional additives, may be incorporated during making the TPU and/or with the TPU polymer pellets to form the TPU compositions of the invention in a subsequent process. The optional additives may be incorporated during the making of the TPU and/or with the TPU polymer pellets to form the TPU compositions of the invention.

In some embodiments, the TPU component of the invention includes a polyether TPU, a polyester TPU, a polycarbonate TPU, or any combination thereof. In some embodiments, the TPU component of the invention includes a polyether TPU and may further include a polyester TPU, a polycarbonate TPU, or any combination thereof. In still other embodiments, the TPU component of the invention includes a polyether TPU and is essentially free of or even completely free of any polyester TPU, polycarbonate TPU, or any combination thereof.

In any of the embodiments described above the TPU material present in the composition can have a number average molecular weight ranging from 100,000 to 700,000, or even from 200,000 to 500,000. The molecular weight of the TPU may be measured by GPC (Gel Permeation Chromatography). These molecular weight ranges may apply independently to any single TPU material present in the composition, but may in other embodiments apply to the overall TPU material present in the composition.

The TPU component may also include one or more other polymeric materials blended with the TPU described above. These optional additional polymeric materials are not overly limited and may include:

(i) a polyolefin (PO), such as polyethylene (PE), polypropylene (PP), polybutene, ethylene propylene rubber (EPR), polyoxyethylene (POE), cyclic olefin copolymer (COC), or combinations thereof;

(ii) a styrenic, such as polystyrene (PS), acrylonitrile butadiene styrene (ABS), styrene acrylonitrile (SAN), styrene butadiene rubber (SBR or HIPS), polyalphamethylstyrene, methyl methacrylate styrene (MS), styrene maleic anhydride (SMA), styrene-butadiene copolymer (SBC) (such as styrene-butadiene-styrene copolymer (SBS) and styrene-ethylene/butadiene-styrene copolymer (SEBS)), styrene-ethylene/propylene-styrene copolymer (SEPS), styrene butadiene latex (SBL), SAN modified with ethylene propylene diene monomer (EPDM) and/or acrylic elastomers (for example, PS-SBR copolymers), or combinations thereof;

(iii) a second thermoplastic polyurethane (TPU);

(iv) a polyamide, such as Nylon™, including polyamide 6,6 (PA66), polyamide 11 (PA11), polyamide 12 (PA12), a copolyamide (COPA), or combinations thereof;

(v) an acrylic polymer, such as poly(methyl acrylate), poly(methyl methacrylate), or combinations thereof;

(vi) a polyvinylchloride (PVC), a chlorinated polyvinylchloride (CPVC), or combinations thereof;

(vii) a polyoxymethylene, such as polyacetal;

(viii) a polyester, such as polyethylene terephthalate (PET), polybutylene terephthalate (PBT), copolyesters and/or polyester elastomers (COPE) including polyether-ester block copolymers such as glycol modified polyethylene terephthalate (PETG) poly(lactic acid) (PLA), or combinations thereof;

(ix) a polycarbonate (PC), a polyphenylene sulfide (PPS), a polyphenylene oxide (PPO), or combinations thereof;

(x) a copolymer of ethylene and vinyl acetate (EVA);

or combinations thereof.

### The Inorganic Phosphinate Component

The compositions of the invention include an inorganic phosphinate. Examples of such materials include salts of phosphinic acids and/or diphosphinic acids or polymeric derivatives thereof. These compounds are referred to herein as inorganic phosphinates and/or metal phosphinates.

In some embodiments, the inorganic phosphinate component of the invention includes an inorganic metal salt of phosphinic acid represented by the formula: [R¹R²P(O)O]⁻ₘM^{m+}, a an inorganic metal salt of diphosphinic acid represented by the formula: [O(O)PR¹—R³—PR²(O)O]²⁻ₙMₓ^{m+}, a polymer of one or more thereof, or any combination thereof, wherein: R¹ and R² are hydrogen; R³ is an alkyl group (containing 1 to 4 or even 1 carbon atoms); M is a metal chosen from the group consisting of Mg, Ca, Al, Sb, Sn, Ge, Ti, Zn, Fe, Zr, Ce, Bi, Sr, Mn, Li, Na, and K; and m, n and x are each independently equal or different integers in the range of 1-4.

Suitable inorganic phosphinates that can be used in the present invention are also described in DE-A 2 252 258, DE-A 2 447 727, PCT/W-097/39053 and EP-0932643-B1. In some embodiments, the inorganic phosphinates are aluminum-, calcium- and/or zinc-phosphinates. In some embodiments, the inorganic phosphinates are aluminum- and/or calcium-phosphinates.

In some embodiments, the inorganic phosphinate component includes inorganic aluminum phosphinate. In some embodiments, the inorganic phosphinate component includes inorganic calcium phosphinate. In some embodiments, the inorganic phosphinate component includes a combination of inorganic calcium phosphinate and inorganic aluminum phosphinate.

### The Melamine Derivative Component

The compositions of the invention include a melamine derivative. Melamine derivatives are well known flame retardants and may be used alone or in combination with one another. Common examples include melamine polyphosphate, melamine pyrophosphate and melamine cyanurate, and mixtures of two or more of these materials.

Such materials may be the reaction product of melamine with a phosphorus acid. These materials are described in greater detail in EP-A-2100919, paragraphs [0024] to [0026]. In some embodiments, the reaction products are obtained by a reaction of essentially equimolar amounts of melamine or of a condensate of melamine with phosphoric acid, pyrophosphoric acid, or polyphosphoric acid. It is common to use melamine polyphosphate, which can be obtained via condensation of melamine phosphate via heating under nitrogen. The phosphorus acid component in the melamine phosphate may be orthophosphoric acid, phosphorous acid, hypophosphorous acid, metaphosphoric acid, pyrophosphoric acid, triphosphoric acid, or tetraphosphoric acid. In some embodiments, the melamine derivative is a melamine polyphosphate obtained via condensation of an adduct of orthophosphoric acid or pyrophosphoric acid with melamine with a degree of condensation of the melamine polyphosphate in some embodiments 5 or greater, or an equimolar adduct salt of polyphosphoric acids with melamine. Cyclic polymetaphosphoric acid can also be used, as well as straight-chain polyphosphoric acid. In some embodiments melamine crystals are used.

In some embodiments, the melamine derivative of the invention includes melamine phosphate, dimelamine phosphate, melamine pyrophosphate, dimelamine pyrophosphate, melamine polyphosphate, melamine nitrilotrisphosphonate, a polyphosphoric acid melamine salt, or a combination thereof.

In some embodiments, the melamine derivative component further comprises a zinc oxide component. The zinc oxide is not believed to react with the other components of the melamine derivative however in some embodiments it is contemplated that the zinc oxide, when present, does not react appreciably with the other components in the phosphate salt flame retardant.

In some embodiments, the melamine derivative of the compositions of the invention include melamine cyanurate, melamine phosphate, melamine polyphosphate, melamine borate, or any combination thereof. In some embodiments, the compositions of the invention include melamine cyanurate.

### Additional Components

The TPU compositions of the invention may also include one or more additional components.

In some embodiments, the additional component is an additional flame retardant. This additional flame retardant may include a boron phosphate flame retardant, a magnesium oxide, a dipentaerythritol, a polytetrafluoroethylene (PTFE) polymer, a phosphate salt flame retardant, a phosphate ester flame retardant, an aromatic phosphate flame retardant, or any combination thereof. In some embodiments, this additional flame retardant may include a boron phosphate flame retardant, a magnesium oxide, a dipentaerythritol, or any combination thereof. A suitable example of a boron phosphate flame retardant is BUDIT 326, commercially available from Budenheim USA, Inc. In some embodiments, this additional flame retardant may include a phosphate ester flame retardant.

When present, the additional flame retardant component may be present in an amount from 0 to 10 weight percent of the overall TPU composition, in other embodiments from 0.5 to 10, or from 1 to 10, or from 0.5 or 1 to 5, or from 0.5 to 3, or even from 1 to 3 weight percent of the overall TPU composition.

Suitable aromatic phosphate flame retardant include monophosphates with aromatic groups, di phosphates with aromatic groups, triphosphates with aromatic groups, or any combination thereof. In some embodiments, the aromatic phosphate flame retardant includes one or more diphosphates with aromatic groups. Examples of such materials include bisphenol A diphosphate.

Suitable examples of compounds that may be used as, or used in combination with, the aromatic phosphate flame retardant of the invention include triaryl phosphate, polyaryl phosphate esters, such as triphenyl phosphate, tricresyl phosphate, trixylyl phosphate, cresyl diphenyl phosphate, diphenyl xylyl phosphate, 2-biphenylydiphenyl phosphate, alkylated polyaryl phosphate esters such as butylated triphenyl phosphate, t-butylphenyl diphenyl phosphate, bis(t-butyl)phenyl phosphate, tris(t-butylphenyl)phosphate, tris(2,4-di-t-butylphenyl)phosphate, isopropylated triphenyl phosphates, isopropylated t-butylated triphenyl phosphates, t-butylated triphenyl phosphates, isopropylphenyl diphenyl phosphate, bis(isopropylphenyl)phenyl phosphate (3,4-diisopropylphenyl)diphenyl phosphate, tris(isopropylphenyl)phosphate, (1-methyl-1-phenylethyl)phenyl diphenyl phosphate, nonylphenyl diphenyl phosphate, 4-[4-hydroxyphenyl(propane-2,2-diyl)]phenyl diphenyl phosphate, 4-hydroxyphenyl diphenyl phosphate, resorcinol bis(diphenyl phosphate), bisphenol A bis(diphenyl phosphate), bis(ditolyl)isopropylidenedi-p-phenylene bis(phosphate), O,O,O′,O′-tetrakis(2,6-dimethylphenyl)-O,O′-m-phenylene bisphosphate, alkylaryl phosphate esters such as 2-ethylhexyl diphenyl phosphate, isodecyl diphenyl phosphate, diethyl phenethylamidophosphate, diisodecyl phenyl phosphate, dibutyl phenyl phosphate, methyl diphenyl phosphate, butyl diphenyl phosphate, diphenyl octyl phosphate, isoctyl diphenyl phosphate, isopropyl diphenyl phosphate, diphenyl lauryl phosphate, tetradecyl diphenyl phosphate, cetyl diphenyl phosphate, tar acids cresylic diphenyl phosphates, trialkyl phosphate esters, such as triethyl phosphate, tributyl phosphate, tri(butoxyethyl)phosphate, 3-(dimethylphosphono)propionic acid methylamide, pentaerythritol cyclic phosphate, and combinations thereof.

Suitable phosphate salt flame retardants, which are different than those described above, include metal salts of phosphoric acid, phosphorous acid, hypophosphorous acid, amine phosphate, or a combination thereof. The phosphate compound in the mixture may include piperazine pyrophosphate, piperazine polyphosphate, or any combinations thereof. In some embodiments, the phosphate salt flame retardant further comprises a zinc oxide component. The zinc oxide is not believed to react with the other components of the phosphate salt flame retardant however in some embodiments it is contemplated that the zinc oxide, when present, does not react appreciably with the other components in the phosphate salt flame retardant.

The TPU compositions of the invention may also include additional additives, which may be referred to as a stabilizer. The stabilizers may include antioxidants such as phenolics, phosphites, thioesters, and amines, light stabilizers such as hindered amine light stabilizers and benzothiazole UV absorbers, and other process stabilizers and combinations thereof. In one embodiment, the stabilizer is Irganox 1010 from Ciba-Geigy Corp. and Naugard 445 from Chemtura. The stabilizer may be used in the amount from about 0.1 weight percent to about 5 weight percent, in another embodiment from about 0.1 weight percent to about 3 weight percent, and in another embodiment from about 0.5 weight percent to about 1.5 weight percent of the TPU composition. In some embodiments, the compositions of the invention may include one or more sterically hindered phenolic antioxidants (for example, Irganox® 245, commercially available from BASF), one or more sterically hindered phenolic amine antioxidants (for example, Argerite Stalite S, commercially available from R.T. Vandervilt), or a combination thereof.

In addition, various conventional inorganic flame retardant and/or filler components may be employed in the flame retardant TPU composition. Suitable examples include any of those known to one skilled in the art, such as metal oxides, metal oxide hydrates, metal carbonates, ammonium phosphate, ammonium polyphosphate, calcium carbonate, antimony oxide, clay, mineral clays including talc, kaolin, wollastonite, nanoclay, montmorillonite clay which is often referred to as nanoclay, and mixture thereof. In one embodiment, the flame retardant package includes talc. The talc in the flame retardant package promotes properties of high LOI. These components may be used in the amount from 0 to about 30 weight percent, from about 0.1 weight percent to about 20 weight percent, in another embodiment about 0.5 weight percent to about 15 weight percent of the total weight of the TPU composition.

For some applications, optional additives, which are not flame retardants, may be used in the TPU compositions of the invention. The additives include colorants, antioxidants (including phenolics, phosphites, thioesters, and/or amines), antiozonates, stabilizers, inert fillers, lubricants, inhibitors, hydrolysis stabilizers, light stabilizers, hindered amines light stabilizers, benzotriazole UV absorber, heat stabilizers, stabilizers to prevent discoloration, dyes, pigments, inorganic and organic fillers, reinforcing agents and combinations thereof. The additives are used in an effective amount customary for these substances. The non-flame retardants additives may be used in amounts of from about 0 to about 30 weight percent, in one embodiment from about 0.1 to about 25 weight percent, and in another embodiment about 0.1 to about 20 weight percent of the total weight of the TPU composition. For this purpose the aromatic phosphate flame retardant and the a phosphate salt flame retardant, as well as the optional flame retardant additives and/or optional additives, can be incorporated into the components of, or into the reaction mixture for, the preparation of the TPU resin, or after making the TPU resin. In another process, all the materials can be mixed with the TPU resin and then melted or they can be incorporated directly into the melt of the TPU resin.

In some embodiments, one or more of the components and/or additional additives described above may be commercially available in a package and/or as a single additive or mixture of additives that can then be added to the TPU compositions of the invention and a pre-blended component. For example, inorganic aluminum phosphinates are commercially available as individual additives, and also pre-mixed with other additives including melamine derivatives such as melamine cyanurate and/or phosphate esters. The TPU compositions of the invention, as well as the processes, methods, and uses described herein may be utilized with either the individual components or the pre-blended components. In some embodiments, the compositions of the invention use individual (non-pre-blended) inorganic aluminum phosphinates. In some embodiments, the compositions of the invention use inorganic aluminum phosphinates pre-blended with melamine cyanurate and/or phosphate esters. Examples of these pre-blended materials include Phoslite B85AX (an inorganic aluminum phosphinates mixed with phosphate ester in about a 85:15 weight ratio) and Phoslite B65AM (an inorganic aluminum phosphinates mixed with melamine cyanurate in about a 60:40 weight ratio), both commercially available from Italmatch.

In one embodiment, the overall TPU composition is substantially halogen-free and in another embodiment the TPU composition is halogen-free.

### INDUSTRIAL APPLICATION

The TPU resin, inorganic phosphinate, and melamine derivative, along with any optional components that may be present, may be compounded together by any means known to those skilled in the art. If a pelletized TPU resin is used, the polymer may be melted at a temperature of about 150° C. to 230° C., preferably from about 160-190° C., and more preferably from about 170-180° C. The particular temperature used will depend on the particular TPU resin used, as is well understood by those skilled in the art. The TPU resin, inorganic phosphinate, and melamine derivative, as well as any optional additives that may be present, may be blended to form an intimate physical mixture. Blending can occur in any commonly used mixing device able to provide shear mixing, but a twin screw extruder having multiple heat zones with multiple feeding ports is preferably used for the blending and melting process.

The TPU resin, inorganic phosphinate, and melamine derivative, along with any optional components that may be present, may be pre-blended before adding to the compounding extruder or they may be added or metered into the compounding extruder in different streams and in different zones of the extruder.

In another embodiment, the TPU resin is not pelletized prior to the addition of the inorganic phosphinate and the melamine derivative. Rather, the process for forming the TPU composition of the invention is a continuous in situ process. The ingredients to form the TPU resin are added to a reaction vessel, such as a twin screw extruder as set forth above. After formation of the TPU resin, the inorganic phosphinate, and the melamine derivative, and any optional components that may be desired, may be added or metered into the extruder in different streams and/or in different zones of the extruder in order to form a TPU composition. The inorganic phosphinate, the melamine derivative, and any optional components that may be desired, may be added in a quantity sufficient to impart at least one predetermined flame retardant characteristic to the composition, as set forth in further detail below.

The resultant TPU composition may exit the extruder die in a molten state and be pelletized and stored for further use in making finished articles. The finished articles may comprise injection-molded parts. Other finished articles may comprise extruded profiles. The TPU composition may be utilized as a cable jacket and/or sheath as set forth in further detail below.

Thermoplastic polyurethanes are generally valued in end use applications because of their abrasion and wear resistance, low temperature flexibility, hydrolytic stability, toughness and durability, ease of processing, tensile strength and other attributes. When additives, such as flame retardants, are present in a TPU composition, there may be some reduction in the desired material properties. The flame retardant package should thus impart the desired flame retardancy, and in some embodiments low smoke properties, without overly sacrificing other material properties, such as tensile strength and in some embodiments percent elongation at break. In the present invention these goals are achieved.

Mechanical properties of flame retardant plastics may be very important for performance of end products. Reference standards for electrical wire and cables such as UL 1581 or similar require certain minimum physical properties for cable jacketing materials. Elongation at break and tensile strength are examples of physical properties specified for cable jacket material. Generally, jacketing material requires having elongation at break higher than 200% and/or tensile strength higher than 1500 psi, or even 2000 psi, or even at least 2300 or 2400 psi. For non-flame retardant plastics, mechanical property requirements are easily met but when it is desired to improve flammability performance, specifically by requiring a minimum LOI, certain mechanical properties may be severely affected. Generally, products with very high LOI have elongation at break lower than 100% and more commonly even less than 50%. Tensile strength of highly flame retardant plastics suitable for cable jackets are generally less than 1500 psi. Moreover, products with very high LOI are generally based on halogen chemistry, commonly fluorine based and sometimes chlorine based. There is no solution available in the market to the inventor's knowledge that can provide these high LOI demonstrated by the invention while still maintaining an elongation at break higher than 150% or even 200%. The present invention provides unexpectedly very high LOI and in some embodiments, can do so while maintaining very high tensile strength, and then even high elongation at break. The ultimate tensile strength and elongation at break of the TPU composition can be measured according to ASTM D412 or VDE282 part 10 (250 mm/min).

Another important property valued for cable jacket application is flexibility. Flexibility can be characterized by the flexural modulus. A lower flexural modulus corresponds to better flexibility. TPUs generally have flexural modulus lower than 20,000 psi whereas other non-TPU products specifically, highly flame retardant products have a flexural modulus 3 to 5 times higher than that of TPUs. The present invention features highly flame retardant product with flexibility typical of TPUs.

Highly flame retardant plastics materials many times suffer from poor processing characteristics and poor surface finish of extruded product. Poor surface finish or processing may be the results of thermally instable flame retardant additives and/or very high levels of additives used. Also, highly flame retardant products are generally completely opaque. The present invention provides highly flame retardant product with excellent processability. The present invention products are thermally stable at TPU processing temperatures. Furthermore, extruded films of the present invention at 30 mil thickness feature translucent appearance and provides partial visibility across the film. Translucency and excellent surface finish are evidence of a good dispersion of additives and processability of present invention.

The TPU compositions may be extruded into the jacket from previously made TPU composition. Usually, the TPU composition is in the form of pellets for easy feeding into the extruder. This method is the most common since the TPU composition is not normally made by the same party that makes the wire and cable construction. However, in accordance with an embodiment of the invention, the wire and cable jacket could be extruded directly from the compounding extruder without going through the separate step of pelletizing the flame retardant TPU composition.

The TPU compositions of the invention, because of their excellent intumescent behavior and good hydrolysis resistance, and in some embodiments also because of their flame retardant properties, abrasion resistance, and/or good tensile strength, are particularly suited for use as insulation and/or jacketing for electrical conductors in wire and cable construction applications, such as jacketing for armored cable, industrial robotic equipment, non-metallic sheath cable, deep well pump cables and other multiple conductor assemblies. The fire performance of a wire and cable construction can be influenced by many factors, with the jacket being one factor. The flammability of the insulation material can also affect the fire performance of the wire and cable construction, as well as other inner components, such as paper wrappings, fillers, and the like. A typical wire and cable construction will have at least one and typically will have multiple electrical conductors, usually from 2 to 8 conductors, such as copper wires. Each conductor will typically be coated, normally by extrusion, with a thin layer of polymeric insulation compound which can be polyvinyl chloride, polyethylene, cross-linked polyethylene, fluorocarbon polymers, and the like. The insulated conductors may be wrapped with metal, a fiberglass or other non-flammable textile. The multiple conductors are then encased in a jacket material (i.e., the TPU composition of this invention) to protect the electrical conductors. It is necessary for this jacket material to be, flame resistant in case a fire occurs.

The invention will be better understood by reference to the following examples.

### EXAMPLES

The invention will be further illustrated by the following examples, which sets forth particularly advantageous embodiments. While the examples are provided to illustrate the invention, they are not intended to limit it.

### Example Set A

A set of TPU compositions is prepared to demonstrate the benefits of the invention. The formulation of each TPU composition is summarized in the table below.

TABLE 1
Example Set TPU Composition Formulations

| Component¹ | 1 | 2 | 3 | 4 | 5 | 6 | 7 | 8 | 9 | 10 | 11 |
|---|---|---|---|---|---|---|---|---|---|---|---|
| TPU A² | 66.8 | 71.8 | 71.8 | 69.8 | 73.8 | 69.8 | 74.8 | 59.8 | 61.8 | 71.8 | 70.8 |
| TPU B² | 0.0 | 0.0 | 0.0 | 0.0 | 0.0 | 0.0 | 0.0 | 0.0 | 0.0 | 0.0 | 0.0 |
| TPU C² | 0.0 | 0.0 | 0.0 | 0.0 | 0.0 | 0.0 | 0.0 | 0.0 | 0.0 | 0.0 | 0.0 |
| Al Phos³ | 8.5 | 8.5 | 15.3 | 12 | 8.5 | 12 | 8.5 | 14.4 | 18 | 12 | 15.3 |
| Ca Phos⁴ | 0.0 | 0.0 | 0.0 | 0.0 | 0.0 | 0.0 | 0.0 | 0.0 | 0.0 | 0.0 | 0.0 |
| Mel Deriv⁵ | 8.0 | 8.0 | 0.0 | 15.0 | 8.0 | 8.0 | 0.0 | 15.6 | 12.0 | 8.0 | 8.0 |
| Phos Ester⁶ | 4.0 | 4.0 | 7.2 | 0.0 | 4.0 | 0.0 | 4.0 | 0.0 | 0.0 | 0.0 | 7.2 |
| Poly Al⁷ | 5.0 | 0.0 | 0.0 | 0.0 | 5.0 | 0.0 | 5.0 | 0.0 | 5.0 | 5.0 | 0.0 |
| Filler⁸ | 10.0 | 10.0 | 10.0 | 3.0 | 3.0 | 10.0 | 10.0 | 10.0 | 3.0 | 3.0 | 3.0 |
| Add Add⁹ | 0.2 | 0.2 | 0.2 | 0.2 | 0.2 | 0.2 | 0.2 | 0.2 | 0.2 | 0.2 | 0.2 |
| Component¹ | 12 | 13 | 14 | 15 | 16 | 17 | 18 | 19 | 20 | 21 | 22 |
| TPU A² | 74.8 | 66.8 | 59.8 | 74.8 | 66.8 | 73.8 | 74.8 | 59.8 | 66.8 | 64.8 | 66.8 |
| TPU B² | 0.0 | 0.0 | 0.0 | 0.0 | 0.0 | 0.0 | 0.0 | 0.0 | 0.0 | 0.0 | 0.0 |
| TPU C² | 0.0 | 0.0 | 0.0 | 0.0 | 0.0 | 0.0 | 0.0 | 0.0 | 0.0 | 0.0 | 0.0 |
| Al Phos³ | 13.2 | 15.3 | 18.0 | 12.8 | 12.8 | 15.3 | 11.9 | 12.0 | 14.5 | 12.0 | 18.0 |
| Ca Phos⁴ | 0.0 | 0.0 | 0.0 | 0.0 | 0.0 | 0.0 | 0.0 | 0.0 | 0.0 | 0.0 | 0.0 |
| Mel Deriv⁵ | 8.8 | 0.0 | 12.0 | 0.0 | 8.0 | 0.0 | 8.0 | 13.0 | 8.0 | 15.0 | 12.0 |
| Phos Ester⁶ | 0.0 | 7.2 | 0.0 | 6.0 | 6.0 | 7.2 | 5.6 | 0.0 | 6.8 | 0.0 | 0.0 |
| Poly Al⁷ | 0.0 | 5.0 | 0.0 | 0.0 | 0.0 | 5.0 | 0.0 | 5.0 | 5.0 | 5.0 | 0.0 |
| Filler⁸ | 3.0 | 10.0 | 10.0 | 10.0 | 10.0 | 3.0 | 3.0 | 10.0 | 3.0 | 3.0 | 3.0 |
| Add Add⁹ | 0.2 | 0.2 | 0.2 | 0.2 | 0.2 | 0.2 | 0.2 | 0.2 | 0.2 | 0.2 | 0.2 |

| Component¹ | 23 | 24 | 25 | 26 | 27 | 28 | 29 | 30 | 31 | 32 |
|---|---|---|---|---|---|---|---|---|---|---|
| TPU A² | 76.8 | 59.8 | 59.8 | 0.0 | 0.0 | 0.0 | 0.0 | 70.0 | 70.0 | 70.0 |
| TPU B² | 0.0 | 0.0 | 0.0 | 70.0 | 0.0 | 0.0 | 67.6 | 0.0 | 0.0 | 0.0 |
| TPU C² | 0.0 | 0.0 | 0.0 | 0.0 | 70.0 | 67.6 | 0.0 | 0.0 | 0.0 | 0.0 |
| Al Phos³ | 15.3 | 15.0 | 16.2 | 11.9 | 11.9 | 14.8 | 14.8 | 11.9 | 6.0 | 0.0 |
| Ca Phos⁴ | 0.0 | 0.0 | 0.0 | 0.0 | 0.0 | 0.0 | 0.0 | 0.0 | 6.0 | 11.9 |
| Mel Deriv⁵ | 2.0 | 10.0 | 15.8 | 8.1 | 8.1 | 9.9 | 9.9 | 8.1 | 8.1 | 8.1 |
| Phos Ester⁶ | 7.2 | 0.0 | 0.0 | 5.6 | 5.6 | 0.0 | 0.0 | 5.6 | 2.8 | 0.0 |
| Poly Al⁷ | 0.0 | 5.0 | 5.0 | 4.9 | 4.9 | 4.7 | 4.7 | 4.9 | 4.9 | 4.9 |
| Filler⁸ | 3.0 | 10.0 | 3.0 | 2.8 | 2.8 | 2.7 | 2.7 | 2.8 | 2.8 | 2.8 |
| Add Add⁹ | 0.2 | 0.2 | 0.2 | 0.2 | 0.2 | 0.2 | 0.2 | 0.2 | 0.2 | 0.2 |

¹All values in the table are percent by weight unless otherwise noted.
²TPU A is polyether TPU, TPU B is a polycarbonate TPU, TPU C is a polyester TPU.
³Al Phos is an inorganic aluminum phosphinate delivered by Phoslite B85AX, B65AM, or B85CX.
⁴Ca Phos is an inorganic calcium phosphinate delivered by Phoslite B85CX.
⁵Mel Deriv is melamine cyanurate, delivered as a separate additive or by Phoslite B65AM.
⁶Phos Ester is phosphate ester, delivered as a separate additive or by Phoslite B85AX.
⁷Poly Al is a polyhydric alcohol.
⁸Filler is talc.
⁹Add Add is a additional additive package that includes a combination of antioxidants. The same additional additive package is used in all of the examples in the example set.

The TPU compositions are then tested for (i) tensile strength (MPa), as measured by VDE282 part 10 (250 mm/min), (ii) percent elongation at break (%), as measured by VDE282 part 10 (250 mm/min), (iii) LOI (%), as measured by ASTM 2863; and (iv) its UL-94 rating. The results of this testing is summarized in the table below.

TABLE 2
Example Set Test Results

| Test | 1 | 2 | 3 | 4 | 5 | 6 | 7 | 8 | 9 | 10 | 11 |
|---|---|---|---|---|---|---|---|---|---|---|---|
| Tensile | 31.3 | 47.2 | 44.3 | 41.2 | 41.8 | 39.5 | 41.8 | 31.1 | 22.2 | 38.5 | 38.4 |
| Elongation | 515 | 478 | 499 | 499 | 534 | 491 | 548 | 496 | 498 | 546 | 563 |
| LOI | 28.5 | 25.5 | 24.5 | 28.5 | 28.0 | 26.0 | 26.5 | 27.5 | 28.5 | 26.5 | 26.5 |
| UL-94 | V2 | V2 | V0 | V2 | V0 | V2 | V2 | V2 | V2 | V2 | V2 |
| Test | 12 | 13 | 14 | 15 | 16 | 17 | 18 | 19 | 20 | 21 | 22 |
| Tensile | 45.4 | 33.9 | 28.5 | 48.3 | 45.6 | 42.0 | 47.6 | 21.3 | 35.1 | 27.0 | 35.4 |
| Elongation | 531 | 537 | 469 | 518 | 492 | 544 | 530 | 456 | 543 | 547 | 520 |
| LOI | 26.0 | 26.5 | 28.0 | 26.0 | 26.0 | 27.0 | 27.0 | 29.5 | 27.0 | 28.5 | 27.5 |
| UL-94 | V2 | V2 | V2 | V2 | V2 | V0 | V2 | V2 | V0 | V0 | V2 |

| Test | 23 | 24 | 25 | 26 | 27 | 28 | 29 | 30 | 31 | 32 |
|---|---|---|---|---|---|---|---|---|---|---|
| Tensile | 48.9 | 23.6 | 21.7 | 37.3 | 33.3 | 28.6 | 32.4 | 37.5 | 39.0 | 36.0 |
| Elongation | 503 | 472 | 486 | 323 | 595 | 558 | 320 | 525 | 526 | 519 |
| LOI | 25.5 | 28.5 | 30.5 | 32.5 | 34.0 | 36.5 | 30.5 | 27.0 | 28.0 | 26.5 |
| UL-94 | V0 | V2 | V0 | V0 | V0 | V0 | V0 | V0 | V1 | V2 |

The results show the TPU compositions of the present invention provide an excellent balance of flame retardant properties while still maintaining good physical properties.

Each of the documents referred to above is incorporated herein by reference. Except in the Examples, or where otherwise explicitly indicated, all numerical quantities in this description specifying amounts of materials, reaction conditions, molecular weights, number of carbon atoms, and the like, are to be understood as modified by the word “about.” Except where otherwise indicated, all numerical quantities in the description specifying amounts or ratios of materials are on a weight basis. Unless otherwise indicated, each chemical or composition referred to herein should be interpreted as being a commercial grade material which may contain the isomers, by-products, derivatives, and other such materials which are normally understood to be present in the commercial grade. However, the amount of each chemical component is presented exclusive of any solvent or diluent oil, which may be customarily present in the commercial material, unless otherwise indicated. It is to be understood that the upper and lower amount, range, and ratio limits set forth herein may be independently combined. Similarly, the ranges and amounts for each element of the invention can be used together with ranges or amounts for any of the other elements. As used herein, the expression “consisting essentially of” permits the inclusion of substances that do not materially affect the basic and novel characteristics of the composition under consideration.

1. (canceled)

2. (canceled)

3. A flame retardant thermoplastic polyurethane composition comprising:
(a) a thermoplastic polyurethane resin;
(b) an inorganic aluminum phosphinate;
(c) a phosphate ester;
(d) an additional flame retardant additive; and
(e) one or more fillers comprising talc;
wherein the talc makes up less than 10 percent by weight of the flame retardant thermoplastic polyurethane composition;
wherein the additional flame retardant additive comprises a melamine derivative, a polyhydric alcohol, or a combination thereof.

4. The flame retardant thermoplastic polyurethane composition of claim 3 wherein the composition further comprises: one or more antioxidants.

5. The flame retardant thermoplastic polyurethane composition of claim 3 wherein the flame retardant thermoplastic polyurethane composition further comprises: one or more phosphate esters.

6. The flame retardant thermoplastic polyurethane composition of claim 3 wherein each of the components (a), (b), and (c) are each essentially halogen-free.

7. The flame retardant thermoplastic polyurethane composition of claim 3 wherein component (a) comprises a polyether thermoplastic polyurethane, a polyester thermoplastic polyurethane, a polycarbonate thermoplastic polyurethane, or any combination thereof.

8. The flame retardant thermoplastic polyurethane composition of claim 3 wherein the thermoplastic polyurethane resin has a molecular weight ranging from 100,000 to 700,000.

9. The flame retardant thermoplastic polyurethane composition of claim 3 component (b) comprises an inorganic aluminum salt of phosphinic acid represented by the formula: [R¹R²P(O)O]⁻₃Al³⁺, an inorganic aluminum salt of diphosphinic acid represented by the formula: [O(O)PR¹—R³—PR²(O)O]²⁻₃Al³⁺₂, a polymer of one or more thereof, or any combination thereof, wherein R¹ and R² are hydrogen and R³ is an alkyl group.

10. The flame retardant thermoplastic polyurethane composition of claim 3 wherein component (b) further comprises an inorganic aluminum salt of phosphinic acid represented by the formula: [R¹R²P(O)O]⁻ₘM^{m+}, a an inorganic metal salt of diphosphinic acid represented by the formula: [O(O)PR¹—R³—PR²(O)O]²⁻ₙMₓ^{m+}, a polymer of one or more thereof, or any combination thereof, wherein: R¹ and R² are hydrogen; R³ is an alkyl group; M is a metal chosen from the group consisting of Mg, Ca, Al, Sb, Sn, Ge, Ti, Zn, Fe, Zr, Ce, Bi, Sr, Mn, Li, Na, and K; and m, n and x are each independently equal or different integers in the range of 1-4.

11. The flame retardant thermoplastic astic polyurethane composition of claim 3 wherein component (c) comprises melamine cyanurate, melamine phosphate, melamine polyphosphate, melamine borate, or any combination thereof.

12. The flame retardant thermoplastic polyurethane compositions of claim 3 wherein the composition is essentially free of (i) polyamides, (ii) organic metal phosphinates, or both.

13. (canceled)

14. (canceled)

15. (canceled)

16. (canceled)

17. (canceled)

18. A method of improving the flame retardant properties of a thermoplastic polyurethane composition comprising (a) thermoplastic polyurethane resin, while maintaining the physical properties of the thermoplastic polyurethane composition, comprising the steps of:
(1) adding to the thermoplastic polyurethane composition:
(b) an inorganic aluminum phosphinate;
(c) a phosphate ester;
(d) an additional flame retardant additive; and
(e) one or more fillers comprising talc;
wherein the talc makes up less than 10 percent by weight of the flame retardant thermoplastic polyurethane composition;
wherein the additional flame retardant additive comprises a melamine derivative, a polyhydric alcohol, or a combination thereof.
resulting in thermoplastic polycarbonate composition with acceptable physical properties and improved flame retardant properties.

19. (canceled)

20. (canceled)

21. The use of an additive composition as a flame retardant properties booster for a thermoplastic polyurethane polyurethane composition comprising (a) thermoplastic polyurethane resin, where the additive composition comprises:
(b) an inorganic aluminum phosphinate;
(c) a phosphate ester;
(d) an additional flame retardant additive; and
(e) one or more fillers comprising talc;
wherein the talc makes up less than 10 percent by weight of the flame retardant thermoplastic polyurethane composition;
wherein the additional flame retardant additive comprises a melamine derivative, a polyhydric alcohol, or a combination thereof.
resulting in thermoplastic polycarbonate composition with acceptable physical properties and improved flame retardant properties.

22. (canceled)

23. (canceled)

24. (canceled)

25. The flame retardant thermoplastic polyurethane composition of claim 3 wherein:
component (a) is included from 45 to 92 percent by weight;
component (b) is included from at least 5 to less than 15 percent by weight;
component (c) is included from 1 to 20 percent by weight;
component (d) is included from at least 1 to 10 percent by weight; and
component (e) is included from at least 1 to less than 10 percent by weight.

26. The flame retardant thermoplastic polyurethane composition of claim 3 wherein:
component (a) is included from 45 to 83 percent by weight;
component (b) is included from at least 15 percent by weight;
component (c) is included from 1 to 20 percent by weight; and
component (d) is included from at least 1 to 10 percent by weight.

27. The flame retardant thermoplastic polyurethane composition of claim 3 wherein:
component (a) is included from 45 to 96 percent by weight;
component (b) is included from at least 5 to less than 15 percent by weight;
component (c) is included from 1 to 20 percent by weight;
component (d) is included from at least 1 to 10 percent by weight; and
component (e) is included from at least 1 to less than 10 percent by weight.

28. The flame retardant thermoplastic polyurethane composition of claim 3 wherein the inorganic aluminum phosphinate makes up less than 18 percent by weight of the flame retardant thermoplastic polyurethane composition.

29. The flame retardant thermoplastic polyurethane composition of claim 3 wherein the inorganic aluminum phosphinate makes up more than 15 percent by weight of the flame retardant thermoplastic polyurethane composition.

30. The flame retardant thermoplastic polyurethane composition of claim 3 wherein the thermoplastic polyurethane resin makes up more than 60 percent by weight of the flame retardant thermoplastic polyurethane composition.
